(19) United States
(12) Patent Application Publication
(10) Pub. No.: US 2021/0042354 A1
(43) Pub. Date: Feb. 11, 2021

(54) SYSTEMS AND METHODS FOR DISPLAYING SUMMARY AND DETAILED INFORMATION REGARDING STRUCTURE TESTING RESULTS IN 2D AND 3D

(71) Applicant: PC-TEL, Inc., Bloomingdale, IL (US)

(72) Inventors: Sumeet Singh Paul, Evanston, IL (US); Stephen V. Saliga, Akron, OH (US); David Adams, Gaithersburg, MD (US)

(21) Appl. No.: 16/988,824

(22) Filed: Aug. 10, 2020

Related U.S. Application Data
(60) Provisional application No. 62/884,535, filed on Aug. 8, 2019.

(51) Int. Cl. G06F 16/904; G06F 16/29; G06F 3/0481; G06T 17/05

(52) U.S. Cl. CPC G06F 16/904; G06T 17/05; G06F 3/04812; G06F 16/29

(57) ABSTRACT

Systems and methods for displaying summary and detailed information regarding structure testing results that include a plurality of RF signal data points are provided. Such systems and methods can include mapping respective 3D location points of each of the plurality of radio frequency signal data points into a plurality of layers of a line of sight dependent 3D image, using respective test result signal components of each of the plurality of RF signal data points to assign a respective color and a respective transparency value to each of the plurality of layers, and rendering one or more of the plurality of layers on a display device relative to a line of sight and in the respective color and at the respective transparency value associated therewith.

### CROSS REFERENCE TO RELATED APPLICATIONS

This application claims priority to U.S. Application No. 62/884,535 filed Aug. 8, 2019 and titled “SYSTEMS AND METHODS FOR DISPLAYING SUMMARY AND DETAILED INFORMATION REGARDING STRUCTURE TESTING RESULTS IN 2D AND 3D.” U.S. Application No. 62/884,535 is hereby fully incorporated by reference as if set forth fully herein.

### FIELD

The present invention relates generally to structure testing results. More particularly, the present invention relates to systems and methods for displaying summary and detailed information regarding structure testing results in 2D and 3D.

### BACKGROUND

When attempting to organize and interact with structure testing results or other structure information for structures from which tremendous amounts of data can be gathered, such as radio network uplink transmission data and radio network downlink transmission data, there are no known systems and methods to provide a visualization of that data at an address (structure/building) level on a map. For example, known systems and methods overlay the data onto street and structural maps, such as Google Maps and Google Earth, in a generic fashion by showing one building as a single color to represent one or more data values that have been summarized for that address. However, such systems and methods fail to interactively display the structure testing results in a detailed manner and for different interior portions of the building.

In view of the above, there is a continuing, ongoing need for improved systems and methods.

### BRIEF DESCRIPTION OF THE DRAWINGS

FIG. 1 is block diagram of a user device according to disclosed embodiments; and

FIG. 2 is a block diagram of a display device of a user device according to disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein can include systems and methods for displaying summary and detailed information regarding structure testing results, such as pass/fail results, in two dimensions (2D) and three dimensions (3D). In some embodiments, the structure testing results can include a plurality of RF signal data points, and in some embodiments, each of the plurality of RF signal data points can include respective 3D location components and respective test result signal components.

In some embodiments, systems and methods disclosed herein can overlay a building architectural drawing over a building on a map. Additionally or alternatively, in some embodiments, systems and methods disclosed herein can display orientation information and/or floor numbers on building floor prints.

In 2D, systems and methods disclosed herein can display the summary information of the building using an aggregate average score for the building or a minimum pass threshold for the building. Furthermore, systems and methods disclosed herein can switch between 2D and 3D, for example, responsive to user input.

In 3D, systems and methods disclosed herein can display the detailed information for the building by displaying each floor of the building and a respective grid on each floor of the building with respective pieces of the structure testing results thereon such that each of the respective pieces of the structure testing results can be identified based on the respective 3D location components and the respective test results signal components associated with a respective grid cell on the respective grid. Accordingly, systems and methods disclosed herein can enable a user to quickly and visually see an overall impact of failed grid points relative to a 3D floor plan of the building in one summary view. For example, in some embodiments, systems and methods disclosed herein can highlight the respective grid or the respective grid cell on each floor of the building that failed a test (e.g. a walk test or a grid test to verify acceptable performance of a wireless network in the building) and transparently display the respective grid or the respective grid cell on each floor of the passed the test. Alternatively, in some embodiments, systems and methods disclosed herein can highlight the respective grid or the respective grid cell on each floor of the building that passed the test and transparently display the respective grid or the respective grid cell on each floor of the building that failed the test.

In accordance with disclosed embodiments, systems and methods disclosed herein can receive user input selecting a particular floor of the building for viewing in 3D. Responsive to that user input, systems and methods disclosed herein can display the detailed information regarding the structure testing results for that particular floor, thereby enabling the user to quickly pinpoint areas in the building to avoid or modify based on the structure testing results.

In some embodiments, systems and methods disclosed herein can display one building in context with surrounding buildings. Accordingly, even when the structure testing results for that one building may be unavailable, systems and methods disclosed herein can display the summary and/or detailed information for the surrounding buildings, thereby providing the user with a general idea of relative coverage in an area without any additional calculations, which can be helpful when attempting to ascertain emergency situations.

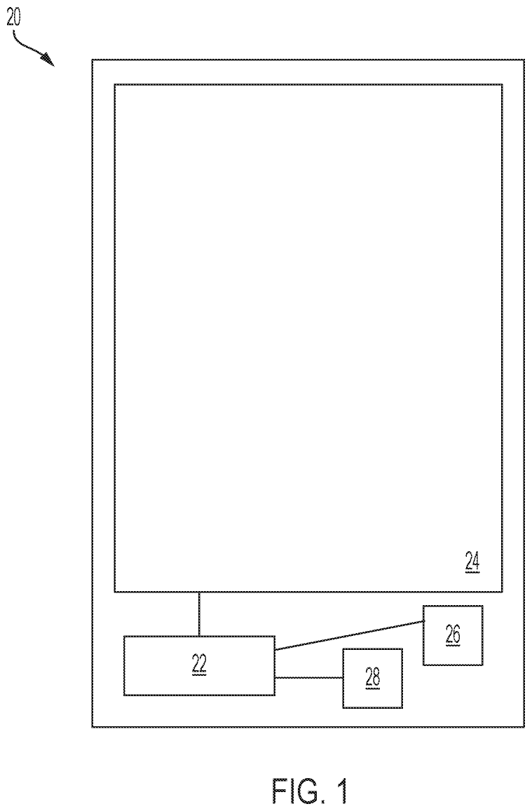

FIG. 1 is a block diagram of a user device 20 according to disclosed embodiments. As seen in FIG. 1, in some embodiments, the user device 20 can include a programmable processor 22, a display device 24, a memory device 26, and a transceiver device 28. In some embodiments, the programmable processor 22 can process a plurality of radio frequency (RF) signal data points for display on the display device 24, and in some embodiments, each of the plurality of RF signal data points can include respective 3D location components and respective test result signal components.

Although the programmable processor 22 and the display device are illustrated as being local to the user device 20 in FIG. 1, it is to be understood that embodiments disclosed herein are not so limited. Instead, in some embodiments, the display device 24 can be located remotely from the programmable processor 22, and in these embodiments, the programmable processor 22 can transmit results of processing the plurality of RF signal data points to the display device 24 via the transceiver device 28.

In some embodiments, the transceiver device 28 can receive the plurality of RF signals, and the plurality of RF signals can be saved in the memory device 26. Accordingly, in these embodiments, the programmable processor 22 can retrieve the plurality of RF signal data points from the memory device 26 for processing thereof

Regardless of how the programmable processor 22 obtains the plurality of RF signal data points for processing, the programmable processor 22 can map the respective 3D location points of each of the plurality of RF signal data points onto a plurality of layers of a line of sight dependent 3D image by associating each of the plurality of RF signal data points with a respective one of a plurality of grid cells on a grid such that each of the plurality of grid cells on the grid can be associated with an area displayed by the line of sight dependent 3D image and treated as a different physical one of the plurality of layers. In some embodiments, the line of sight dependent 3D image can be a virtual 3D image configured to be displayed on a 2D display. Then, the programmable processor 22 can use the respective test result signal components of each of the plurality of RF signal data points to assign a respective color and a respective transparency value to each of the plurality of layers and direct the display device 24 to render one or more of the plurality of layers thereon relative to a line of sight and in the respective color and at the respective transparency value associated therewith. In some embodiments, each of the plurality of layers can be rendered parallel to the line of sight.

In some embodiments, the programmable processor 22 can identify the line of sight from first user input received directly by the user device 20 or via the transceiver device 28. Furthermore, in some embodiments, the programmable processor 22 can update the line of sight responsive to additional and/or subsequent user input, and responsive thereto, direct the display device 24 to render the one or more of the plurality of layers thereon relative to the line of sight as updated.

Additionally or alternatively, in some embodiments, the programmable processor 22 can direct the display device 24 to render the one or more of the plurality of layers relative to a geographic location. For example, in these embodiments, the programmable processor 22 can identify the geographic location from the memory device 26 and/or any received user input. Then, when retrieving the plurality of RF signal data points, for example, from the memory device 26, the programmable processor 22 can limit the plurality of RF signal data points to ones in which the respective 3D location points are within a predetermined range of the geographic location and can direct the display device 24 to render the one or more of the plurality of layers on the display device 24 over a map corresponding to the geographic location. In some embodiments, the geographic location can include a building, and the map can include an architectural drawing of the building. Additionally or alternatively, in these embodiments, the geographic location can include a particular floor of the building, and the map can include a floor plan of that particular floor of the building.

In some embodiments, the programmable processor 22 can use the respective test result signal components of each of the plurality of RF signal data points to identify the respective color and the respective transparency value to assign to each of the plurality of layers by comparing the respective test result signal components of each of the plurality of RF signal data points to one or more threshold values. As such, systems and methods disclosed herein can visually display positive test results and negative test results differently.

As a specific, but non-limiting example, in some embodiments, the programmable processor 22 can assign the respective color of any of the plurality of layers associated with any of the plurality of RF signal data points to be a first color, for example, green, and the respective transparency value of any of the plurality of layers associated with any of the plurality of RF signal data points to be a first transparency value, for example, 90 percent, when the respective test result signal components are indicative of the positive test results, that is, greater than or equal to the one or more threshold values compared thereto and assign the respective color of any of the plurality of layers associated with any of the plurality of RF signal data points to be a second color, for example, red, and the respective transparency value of any of the plurality of layers associated with any of the plurality of RF signal data points to be a second transparency value, for example, 0 percent, when the respective test result signal components are indicative of the negative test results, that is, less than the one or more threshold values compared thereto. In some embodiments, the one or more threshold values can include a 90 percent or other predetermined positivity rate.

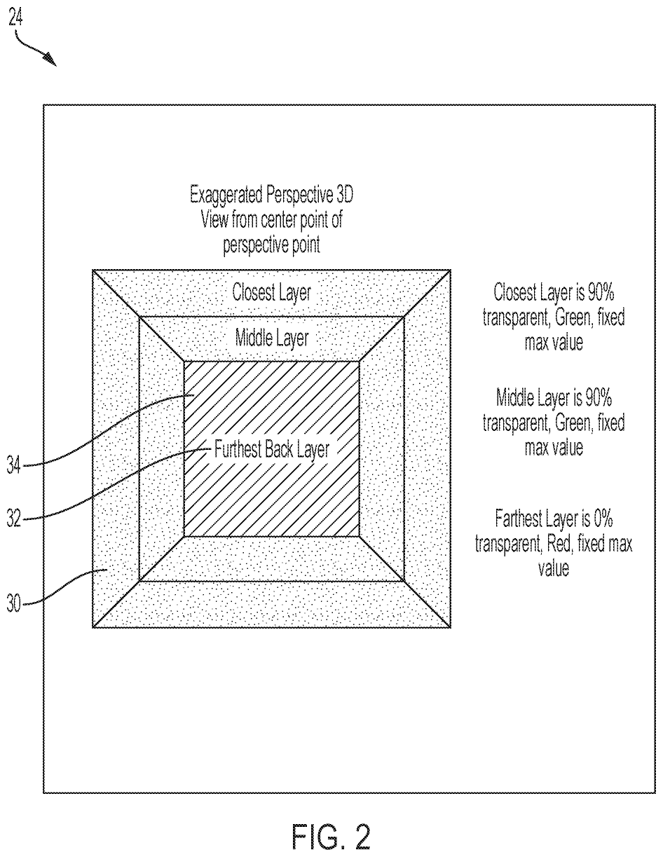

FIG. 2 illustrates the display device 24 rendering the plurality of layers of the line of sight dependent 3D image according to disclosed embodiments. In accordance with the specific, but non-limiting example described above, a closest layer 30 of the plurality of layers can be displayed in green and with 90% transparency, a middle layer 32 of the plurality of layers can be displayed in green and with 90% transparency, and a farthest layer 34 of the plurality of layers can be displayed in red with 0% transparency.

In some embodiments, the programmable processor 22 and/or the display device 24 can bypass a normal operation of stacked, transparent ones of the plurality of layers, which would otherwise result in an additive component of the respective color of each of the plurality of layers being displayed. For example, the programmable processor 22 and/or the display device 24 can render each of any stacked groupings of the plurality of layers for which the respective test result signal components are indicative of the positive test results, that is, are greater than or equal to the one or more threshold values, as a unified group having a single color and a single transparency value and render any stacked groupings of the respective ones of the plurality of layers for which the respective test result signal components are indicative of the negative test results, that is, less than the one or more threshold values, individually and according to the respective color and the respective transparency value assigned thereto.

As another specific, but non-limiting example, with the positive test results, such as when the respective color assigned to two consecutive ones of the plurality of layers for which the respective test result signal components are greater than or equal to the one or more threshold values is green (represented by the standard RGB hexadecimal value 0x0F), a combination of the two consecutive ones of the plurality of layers would normally result in a displayed RGB value of 0x1E. However, in accordance with embodiments disclosed herein, such an additive value can be limited so that the displayed RGB value of the combination of the two consecutive ones of the plurality of layers can be equal to the respective color assigned to a single one of the two consecutive ones of the plurality of layers (e.g. 0x0F). However, in some embodiments, with the negative test results, such as when the respective color assigned to any of the plurality of layers for which the respective test result signal components are less than the one or more threshold values is red, can be additive, which can result in displaying ever darker shades of red when those ones of the plurality of layers are stacked together. As such, in some embodiments, the above-described features of limiting and allowing additive values can render the line of slight dependent 3D image in which there is a green tinge or haze in locations of the positive test results along the line of sight and strong red indications when the line of sight intersects with a failure point, that is, the negative test results.

Additionally or alternatively, in some embodiments, systems and methods disclosed herein can limit the additive values by modifying a standard BitBlt operation known in the art. In particular, the standard BitBlt method compares individual bits of two overlapping values and ANDs the individual bits together individually. For example, when 2 bits are used for each color (R,G,B) to limit text space, a final result of b110111 can result in a 3-layer stack in which layer 1 has a value of b100000, layer 2 has a value of b000110, and layer 3 has a value of b010101. In contrast, systems and methods disclosed herein can implement a modified BitBlt operation that can produce a final result of b110100 for a 3-layer stack in which layer 1 has a value of b000100, layer 2 has a value of b000100, and layer 3 has a value of b110000 so as to render red and light green pixels within one or more of the plurality of layers.

For example, when systems and methods disclosed herein implement the modified BitBlt operation, one or more of the plurality of layers can be rendered by masking a new one of the plurality of layers (e.g. a closer one of the plurality of layers), using an old one of the plurality of layers (e.g. previously combined ones of the plurality of layers) to limit current layer areas where a previous one of the plurality of layers was blank (e.g. where the previous one of the plurality of layers had no value), and performing an AND operation. Then, a mask value can be changed to red areas of the old one of the plurality of layers and an AND operation can be performed again. Such an iterative process can produce new areas of data that include any previous areas that were red. Finally, another mask of previously designated green ones of the plurality of layers combined with a current empty one of the plurality of layers can be employed to allow a bit copy operation to be performed for remaining pixels of the one or more of the plurality of layers.

Although a few embodiments have been described in detail above, other modifications are possible. For example, other components may be added to or removed from the described systems, and other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

What is claimed is:

1. A method comprising:
receiving or retrieving a plurality of radio frequency (RF) signal data points, each of the plurality of RF signal data points including respective three-dimensional (3D) location components and respective test result signal components;
mapping the respective 3D location points of each of the plurality of RF signal data points into a plurality of layers of a line of sight dependent 3D image;
using the respective test result signal components of each of the plurality of RF signal data points to assign a respective color and a respective transparency value to each of the plurality of layers; and
rendering one or more of the plurality of layers on a display device relative to a line of sight and in the respective color and at the respective transparency value associated therewith.

2. The method of claim 1 further comprising:
comparing the respective test result signal components of each of the plurality of RF signal data points to one or more threshold values to identify the respective color and the respective transparency value to assign to each of the plurality of layers.

3. The method of claim 2 further comprising:
assigning the respective color of a first of the plurality of layers to be a first color and the respective transparency value of the first of the plurality of layers to be a first percentage when the respective test result signal components are greater than or equal to the one or more threshold values; and
assigning the respective color of a second of the plurality of layers to be a second color and the respective transparency value of the second of the plurality of layers to be a second percentage when the respective test result signal components are less than the one or more threshold values.

4. The method of claim 3 wherein the one or more threshold values includes a predetermined percent positivity rate.

5. The method of claim 2 further comprising:
rendering any stacked groupings of the plurality of layers for which the respective test result signal components are greater than or equal to the one or more threshold values as a unified group having a single color and a single transparency value; and
rendering each of any stacked groupings of the plurality of layers for which the respective test result signal components are less than the one or more threshold values individually and according to the respective color and the transparency value assigned thereto.

6. The method of claim 5 further comprising:
limiting an additive value of each of the stacked groupings of the plurality of layers for which the respective test result signal components are greater than or equal to the one or more threshold values.

7. The method of claim 5 wherein the single color and the single transparency value are equal to the respective color and the respective transparency value of one layer in the stacked groupings of the plurality of layers for which the respective test result signal components are greater than or equal to the one or more threshold values.

8. The method of claim 1 further comprising:
rendering each of the plurality of layers parallel to the line of sight.

9. The method of claim 1 further comprising:
identifying the initial line of sight from first user input received by a user device; and
updating the line of sight responsive to additional user input.

10. The method of claim 1 further comprising:
identifying a geographic location;
limiting the plurality of RF signal data points to ones in which the respective 3D location points are within a predetermined range of the geographic location; and
rendering the one or more of the plurality of layers on the display device over a map corresponding to the geographic location.

11. A system comprising:
a programmable processor; and
a display device
wherein the programmable processor receives or retrieves a plurality of radio frequency (RF) signal data points,
wherein each of the plurality of RF signal data points include respective three-dimensional (3D) location components and respective test result signal components,
wherein the programmable processor maps the respective 3D location points of each of the plurality of RF signal data points into a plurality of layers of a line of sight dependent 3D image, uses the respective test result signal components of each of the plurality of RF signal data points to assign a respective color and a respective transparency value to each of the plurality of layers, and
wherein the display device renders one or more of the plurality of layers relative to a line of sight and in the respective color and at the respective transparency value associated therewith.

12. The system of claim 11 wherein the programmable processor compares the respective test result signal components of each of the plurality of RF signal data points to one or more threshold values to identify the respective color and the respective transparency value to assign to each of the plurality of layers.

13. The system of claim 12 wherein the programmable processor assigns the respective color of a first of the plurality of layers to be a first color and the respective transparency value of the first of the plurality of layers to be a first percentage when the respective test result signal components are greater than or equal to the one or more threshold values and assigns the respective color of a second of the plurality of layers to be a second color and the respective transparency value of the second of the plurality of layers to be a second percentage when the respective test result signal components are less than the one or more threshold values.

14. The system of claim 13 wherein the one or more threshold values includes a predetermined percent positivity rate.

15. The system of claim 12 wherein the display device renders any stacked groupings of the plurality of layers for which the respective test result signal components are greater than or equal to the one or more threshold values as a unified group having a single color and a single transparency value and renders each of any stacked groupings of the plurality of layers for which the respective test result signal components are less than the one or more threshold values individually and according to the respective color and the transparency value assigned thereto.

16. The method of claim 15 wherein the programmable processor limits an additive value of each of the stacked groupings of the plurality of layers for which the respective test result signal components are greater than or equal to the one or more threshold values.

17. The method of claim 15 wherein the single color and the single transparency value are equal to the respective color and the respective transparency value of one layer in the stacked groupings of the plurality of layers for which the respective test result signal components are greater than or equal to the one or more threshold values.

18. The system of claim 11 wherein the display device renders each of the plurality of layers parallel to the line of sight.

19. The system of claim 11 wherein the programmable processor identifies the line of sight from first user input received by a user device, and wherein the programmable processor updates the line of sight responsive to additional user input.

20. The system of claim 11 wherein the programmable processor identifies a geographic location, wherein the programmable processor limits the plurality of RF signal data points to ones in which the respective 3D location points are within a predetermined range of the geographic location, and wherein the display device renders the one or more of the plurality of layers on the display device over a map corresponding to the geographic location.
